(19) United States
(12) Patent Application Publication
(10) Pub. No.: US 2008/0267860 A1
(43) Pub. Date: Oct. 30, 2008

(54) Crystalline Microporous Material Of Zeolitic Nature

(75) Inventors: Avelino Corma Canos, Valencia (ES); Fernando Rey Garcia, Valencia (ES); Maria Jose Diaz-Cabanas, Valencia (ES); Jose Luis Jorda Moret, Valencia (ES); Angel Cantin Sanz, Valencia (ES); Manuel Moliner Marin, Valencia (ES)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., Amersfoort (NL)

(21) Appl. No.: 12/023,917

(22) Filed: Jan. 31, 2008

Related U.S. Application Data
(60) Provisional application No. 60/899,063, filed on Feb. 2, 2007.

(51) Int. Cl. C01B 39/02; C01B 39/00

(52) U.S. Cl. 423/701; 423/718

(57) ABSTRACT

A crystalline microporous material of zeolitic nature (ITQ-41) having in its calcined form a chemical composition represented by the empirical formula:

x(M_{1/n}XO₂):yYO₂:SiO₂

wherein,
Y is a chemical element other than Silicon with oxidation status +4;
X is a chemical element with oxidation status +3;
M is H⁺ or an inorganic cation with charge n⁺;
n can take any value between 1 to 3;
x can take any value comprised between from about 0 to about 0.2; preferably lower than 0.0666, and more preferably lower than 0.05;
y can take any value comprised between 0 and 0.2, and
   wherein, said material is characterized by the presence of four reflections in its powder X-Ray diffraction pattern at 6.9°; 7.4°; 8.3°, and 9.6°2θ angles.

This invention relates to a microporous crystalline material of zeolitic nature, to the process of its preparation and its use in processes of transformation and separation of organic compounds. The process of preparation is characterized by the use of at least one specific organic additive, which is crystallized through heating.

Synthetic and naturally occurring crystalline zeolites consist structurally of an open three-dimensional framework of TO₄ tetrahedra, wherein T represents atoms with formal oxidation states of +3 and +4, typically Si and Al but also elements such as Ti, Ge, B and Ga. Such tetrahedra are cross-linked by the sharing of oxygen atoms so that the ratio of oxygen atoms to the total of the trivalent (e.g. Al) and tetravalent (e.g. Si) atoms is equal to two. The negative electrovalence of tetrahedra containing trivalent elements is balanced by the inclusion of organic and inorganic cations within the crystal structure.

Synthetic crystalline zeolites are distinguishable from each other and from naturally occurring zeolites on the basis of both composition and crystalline structure. Many zeolites possess a crystal structure comprising systems of channels and/or cavities of molecular dimensions; differences in these systems between zeolites yields distinct and characteristic powder X-ray diffraction patterns.

The interstitial spaces of the zeolite crystal structure are generally occupied by water of hydration. After at least partial dehydration, these zeolites may be used as efficient adsorbents whereby adsorbent molecules are retained within those interstitial spaces. Obviously, the interstitial dimensions of the openings in the crystal lattice limit the size and shape of the molecules that can be so adsorbed. The distinct selective adsorption properties of many crystalline zeolites is critical to their functionality as “sieves” for molecules of certain dimensions and is also critical to their efficacy when used in ion-exchange processes and as catalysts or catalyst additives/components.

U.S. Pat. Reissue No. 28,341 and U.S. Pat. Nos. 3,308,069; 3,923,641; 4,676,887; 4,812,223; 4,486,296; 4,601,993, and 4,612,108 all describe the composition, method of production and X-ray powder diffraction analysis of beta zeolites. These large pore, synthetic crystalline zeolites have a molar silica to alumina ratio of at least 25, typically at least 100 and potentially greater than 250, and have the characteristic powder X-ray diffraction pattern illustrated in FIG. 1 appended hereto.

The structure of beta zeolite was first described by Newsam et. al in Proceedings of Royal Society London Ser. A, 410 (1998) 375-405 as being characterized by tetragonal lattice parameters of about 12.6×12.6×26.2 Å and a three dimensional pore system constructed of 12-member rings. More specifically, zeolite beta was rationalized to consist of an intergrowth of two distinct sheet-like structures, termed polymorphs A and B. Both these polymorphs comprise a three-dimensional network of 12-ring pores; the intergrowth of the polymorphs does not significantly affect these pores in two of the dimensions but, in the direction of the faulting, the pores becomes tortuous but not blocked. As a consequence beta zeolite is often described as being more structurally defective than, for example, ZSM-5 and zeolite Y.

The aforementioned paper of Newsam et al. had proposed the presence of a third polymorph—termed polymorph C—in the beta zeolite structure but it was subsequently concluded that this polymorph C was not present. [Zeolites, 5/6, (1996), 641]. Recently, however, a material closely related to Beta zeolite was synthesised in which the polymorph C appeared with polymorphs A and C at a more significant concentration level than that of an impurity [Corma et al. ITQ-16, a new zeolite family of the beta group with different proportions of polymorphs A, B and C Chem. Commun. (2001) 1720]. Further, the synthesis of that polymorph C as a pure silico-germanate—a material known as ITQ-17—has also been described [Corma et al. “Pure polymorph C of zeolite beta synthesized by using framework isomorphous substitution as a structure-directing mechanism” Angew. Chem. Int. Ed., 49(12), 2277-2280, (2001)].

To date however no zeolitic material has been reported in which that polymorph C appears in combination with only one of polymorph A or polymorph B. The object of this invention is to provide such a novel zeolitic material and to determine the optimum uses for said material.

The present invention relates to a crystalline microporous material of zeolitic nature, hereinafter referred to as ITQ-41, to its process of preparation and to its applications.

Such material is characterized by its chemical composition and by its X-ray diffraction pattern. In its anhydrous and roasted forms, the chemical composition of ITQ-41 may be represented by means of the empirical formula:

x(M_{1/n}XO₂):yYO₂:SiO₂

wherein,
Y is a chemical element other than Silicon with oxidation status +4;
X is a chemical element with oxidation status +3;
M is H⁺ or an inorganic cation with charge n⁺;
n can take any value in the range from 1 to 3;
x can take any value greater than or equal to 0 and less than about 0.2, preferably less than about 0.0666, and more preferably, less than about 0.05;
y can take any value greater than or equal to 0 and less than about 0.2, preferably less than about 0.1, and more preferably less than about 0.0666, and
said composition is characterized by the presence of four reflections in the X-Ray diffraction pattern at 6.9°, 7.4°, 8.3° and 9.6° 2θ angles. These reflections distinguish this composition from Beta zeolite, ITQ-16 and ITQ-17.

In the above empirical formula, Y preferably comprises at least one element selected from the group consisting of Ge, Ti, Sn, and V. Independently, it is preferable that X comprises at least one element selected from the group consisting of Al, Ga, B, Cr and Fe. Further, it is preferable that M comprises at least one mono or divalent element selected from the group consisting of H⁺, Li⁺, Na⁺, K⁺, Ca²⁺ and Mg²⁺.

In a preferred embodiment of the present invention, ITQ-41 has the composition in its calcined (roasted and anhydrous state):

x(HXO₂):SiO₂

wherein, X is a trivalent element and x possesses a value greater than or equal to 0 and less than about 0.02.

In that embodiment wherein both x=0 and y=0, the material may be described as a new polymorphic form of silica (SiO₂) characterized by its microporous character. More particularly, the calcined material may be characterized by an X-Ray diffraction pattern, which can be fitted by the Rietveld Refinement as a combination of the two polymorphs B and C. [The disclosure of H. M. Rietveld “A profile refinement method for nuclear and magnetic structures”, Journal of Applied Crystallography 2: 65-71 (1969) is herein incorporated by reference].

In accordance with that preferred embodiment of that material wherein x=0 and y=0, the ratio of polymorph B to polymorph C is in the range from about 0:100 to about 100:0, preferably in the range from about 5:95 to about 95:5, and more preferably in the range from about 15:85 to about 85:15.

Depending on the method of synthesis and on its roasting or subsequent treatments, the existence of defects in the crystal lattice is possible. These are manifested by the presence of Si—OH groups (silanoles); said defects have not been included in the aforementioned empirical formulas.

In accordance with a second aspect of the invention there is provided a method for synthesizing the microporous crystalline material of zeolitic nature (ITQ-41) wherein in its anhydrous and roasted forms, the chemical composition of ITQ-41 may be represented by means of the empirical formula:

x(M_{1/n}XO₂):yYO₂:SiO₂

wherein,
Y is a chemical element other than Silicon with oxidation status +4;
X is a chemical element with oxidation status +3;
M is H⁺ or an inorganic cation with charge n⁺;
n can take any value in the range from 1 to 3;
x can take any value greater than or equal to 0 and less than about 0.2, preferably less than about 0.0666, and more preferably, less than about 0.05;
y can take any value greater than or equal to 0 and less than about 0.2, preferably less than about 0.1, and more preferably less than about 0.0666, and
said composition is characterized by the presence of four reflections in the X-Ray diffraction pattern at 6.9°, 7.4°, 8.3° and 9.6° 2θ angles, and
   wherein, said method comprises:
a) providing a reaction mixture comprising:
   a source of silica (SiO₂);
   a source of the 4,4-dimethyl-4-azonium-tricyclo[5,2,2,0^{2,6}]undec-8-ene cation as a structure directing agent, said cation hereinafter being denoted as R+;
   a source of fluoride ions;
   a source of Y, where applicable;
   a source of X, where applicable, and water, and
wherein, said reaction mixture has a composition characterized by the following ratios calculated in terms of oxide unless otherwise directed:
   X₂O₃/SiO₂ ranges from 0 to about 0.2
   ROH/SiO₂ ranges from about 0.01 to about 3
   YO₂/SiO₂ ranges from 0 to about 0.2
   H₂O/SiO₂ ranges from about 1000 to about 0.25
   HF/SiO₂ ranges from about 0.01 to about 3.0
b) subjecting said reaction mixture to heating at a temperature in the range from about 110 to about 250° C., and at a pH between about 5 to about 10 until crystallization is obtained.

It is preferred that the reaction mixture has a composition characterized by the following ratios calculated in terms of oxide unless otherwise directed:
X₂O₃/SiO₂ ranges from 0 to about 0.066, more preferably from 0 to about 0.05;
ROH/SiO₂ ranges from about 0.03 to about 1.0;
YO₂/SiO₂ ranges from 0 to about 0.1, more preferably from 0 to about 0.066;
H₂O/SiO₂ ranges from about 100 to about 1.0; and
HF/SiO₂ ranges from about 0.03 to about 1.0.

Preferably, the source of silicon comprises at least one of amorphous silica, colloidal silica, silica gel, tetraalkylorthosilicate and preformed zeolite. Independently, it is preferable that said structure directing agent (R+) is present in the mixture in at least one of its hydroxide, nitrate, chlorate, sulphate, bisulphate, carbonate, bicarbonate forms. Further, it is preferable that said source of fluoride comprises at least one of hydrofluoric acid, ammonium fluoride, alkaline metal fluoride and alkaline-earth metal fluoride.

In accordance with a preferred embodiment of this method, said reaction mixture further comprises a source of alkaline or alkaline earth cations. Preferably said cations are present in the form of their hydroxides, halides, nitrates, chlorates, sulphates, bisulphates, carbonates or mixtures thereof. It is most preferred that said mixture comprises a source of potassium cations.

If said alkaline or alkaline earth metal cations are denoted as A within said preferred embodiment, the reaction mixture preferably has a composition wherein:
A/SiO₂ ranges from about 3 to about 0.01, preferably from about 1 to about 0.03, and
A/ROH ranges from 0 to about 5, preferably from 0 to about 2.

The preferred conditions under which crystallization is induced within the reaction mixture (step (b) above) comprise temperatures between about 130 to about 200° C. Once the crystallization process is finished, the solid is recovered from the mother liquor by filtration and/or centrifugation. The solid is dried, preferably at temperatures between about 25 to about 150° C.

As a proportion of the cation R is occluded in the channels and cavities of the crystalline product of the aforementioned method, it is preferred to drive off that cation by subjecting said product to appropriate heating. Preferably, the occluded organic, and any occluded fluoride anions, are removed by calcination under vacuum, in air, N₂, or other inert gas, at temperatures higher than about 400° C., preferably higher than about 450° C., but lower than about 1200° C.

In accordance with a third aspect of the invention, there is provided a method of enriching an ITQ-41 material with polymorph C, said method comprising:
i) providing a first ITQ-41 material having a first ratio of polymorph C to polymorph B;
ii) adding said first ITQ-41 material under stirring to an aqueous solution of 4,4 dimethyl-4-azonium-tricyclo[5,2,2,0^{2,6}]undec-8-ene cation as a structure directing agent, and further adding a source of alkaline or alkaline earth metals and a source of fluoride ions, and
iii) subjecting the gelatinous reaction mixture thus formed to heating at a temperature between about 110° and about 250° C. until crystallization occurs.

Said crystallization product, a second ITQ-41 material enriched in polymorph C compared to said first ITQ-41 material, may be further separated from any mother liquor present, washed and/or calcined under the conditions described above.

The fourth aspect of this invention concerns the use of the ITQ-41 material as a molecular sieve in fluid separation, including the use of said material as a desiccant; in ion-exchange processes; as a catalyst in itself, or as a catalyst additive or catalyst component.

More particularly, the ITQ-41 material may be used: i) as an additive for catalytic cracking catalysts of hydrocarbons or other organic compounds; ii) as a component of or additive to hydrocracking or mild hydrocracking catalysts; iii) as a component of or additive to light paraffin isomerization catalysts; iv) as a component of or additive to dewaxing and isodewaxing catalysts; v) as an alkylation catalyst of isoparaffins with olefins or alcohols; vi) as an alkylation catalyst of aromatic compounds or substituted aromatic compounds with olefins or alcohols wherein it is preferably employed as an alkylation catalyst of benzene with propylene; vii) as a catalyst for acylation of aromatic compounds using acids, acyl chlorides, anhydrides of organic acids as acylant agents; ix) as a catalyst for Meerwein-Pondorf-Verley and Oppenauer reactions, and x) as a catalyst for the removal of organic vapours (VOC).

Furthermore, Ti containing ITQ-41 materials may be used as active catalysts for olefin epoxidation, alkane oxidation, alcohol oxidation, tioether oxidation to sulfoxide or sulfones reactions using organic or inorganic hydroperoxides, such as H₂O₂, tertbutylhydroperoxide and cumenehydroperoxide as oxidant agents.

Also, Sn containing ITQ-41 materials may be used as active catalysts for Bayer-Williger oxidation reactions using H₂O₂ as oxidant. Finally, the employ as an active catalyst for the cyclohexanone ammoximation to cyclohexanone oxime in presence of ammonia and H₂O₂.

### BRIEF DESCRIPTION OF THE DRAWINGS

FIG. 1 illustrates a characteristic X-ray diffraction of a beta zeolite. This figure is taken from Perez et al. Applied Catalysts 31 (1987) 35.

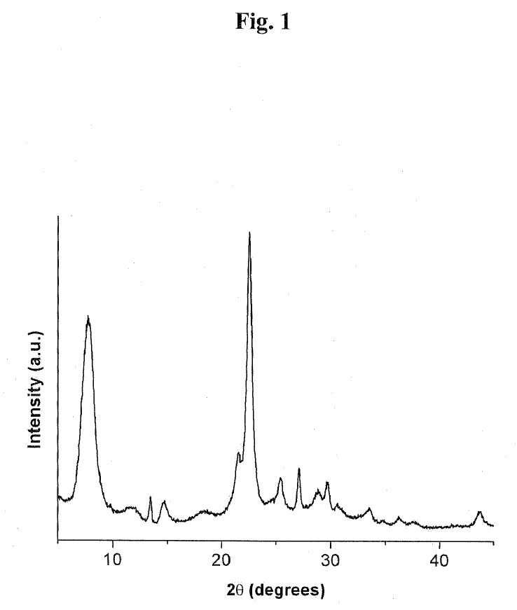

FIG. 2 illustrates an X-ray diffraction pattern of the crystalline microporous material of zeolitic nature ITQ-16.

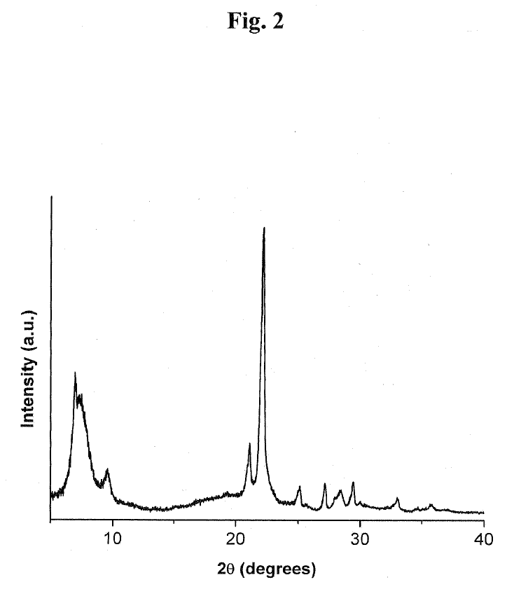

FIG. 3 illustrates an X-ray diffraction pattern of a pure silica ITQ-41 material in its uncalcined form and having a polymorph C to B ratio of 70:30.

FIG. 4 illustrates an X-ray diffraction pattern of a pure silica ITQ-41 material in its calcined form and having a polymorph C to B ratio of 70:30.

FIG. 5 illustrates the Rieteveld refinement of the X-ray diffraction pattern of FIG. 4.

FIG. 6 illustrates X-ray diffraction patterns of pure polymorph B and pure polymorph C.

FIG. 7 illustrates an X-ray diffraction pattern of the crystalline microporous material of zeolitic nature prepared in accordance with Example 2 described hereinbelow.

FIG. 8 illustrates an X-ray diffraction pattern of the crystalline microporous material of zeolitic nature prepared in accordance with Example 3 described hereinbelow.

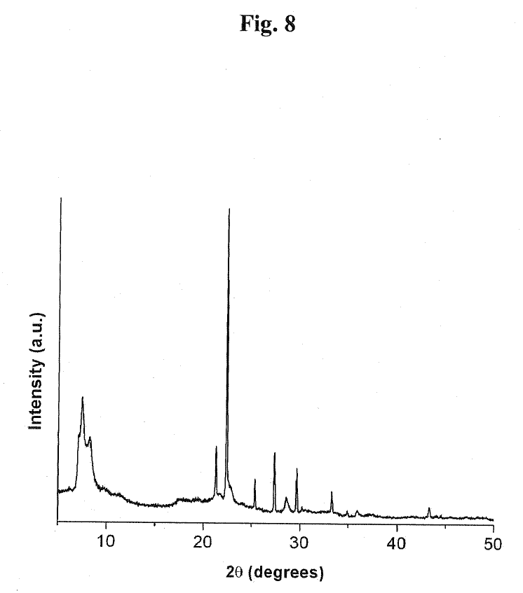

FIG. 9 illustrates an X-ray diffraction pattern of the crystalline microporous material of zeolitic nature prepared in accordance with Example 4 described hereinbelow.

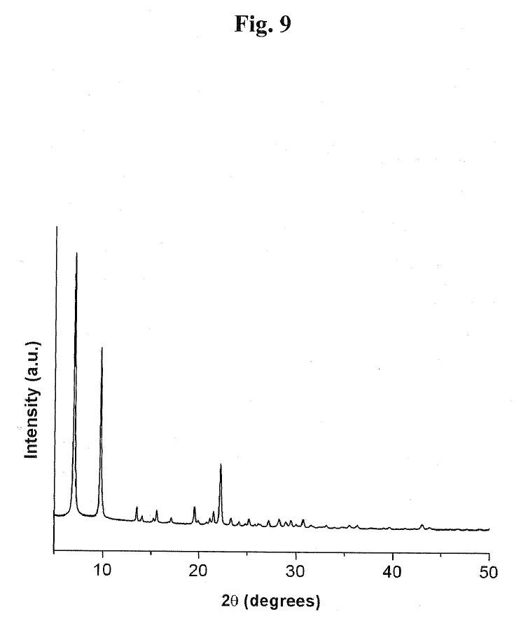

FIG. 10 illustrates an X-ray diffraction pattern of the crystalline microporous material of zeolitic nature prepared in accordance with Example 5 described hereinbelow.

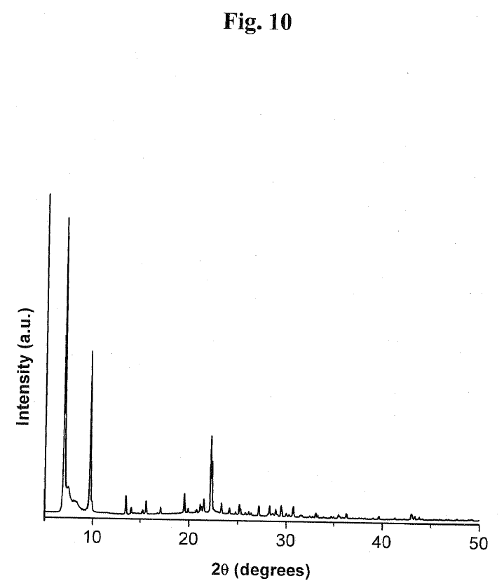

### SYNTHESIS OF THE STRUCTURE DIRECTING AGENT 4,4-DIMETHYL-4-AZONIUM-TRICYCLO[5.2.2.0^{2,6}]UNDEC-8-ENE HYDROXIDE (ROH)

A toluene solution (350 mL) of 1,3-cyclohexadiene (10 mL; 103 mmol) and maleimide (10 g; 103 mmol) was refluxed for 4 days. After cooling, the resulting precipitate was filtered and washed with hexane to give the Diels-Alder product in quantitative form (23 g).

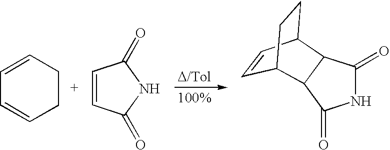

A 1.0 M solution of LiAlH₄ in anhydrous diethyl ether (127 mL; 127 mmol) was added dropwise under N₂ to a stirred suspension of the Diels-Alder adduct (9.0 g; 51 mmol) in anhydrous diethyl ether (71 mL) at 0° C. When the addition was finished, the mixture was refluxed for 5 hours and stirred at room temperature overnight. Then, the reaction was quenched by addition of H₂O (10 mL), 15% aqueous solution of NaOH (10 mL) and distilled H₂O (10 mL). After 30 minutes stirring at room temperature, the solution was filtered and then extracted with diethyl ether. The combined organic extracts were washed with brine, dried and concentrated to dryness providing the corresponding reduced product (6.8 g; 89%).

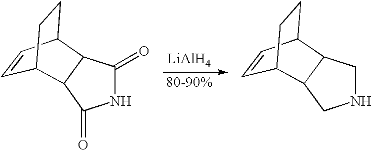

To a solution of the secondary amine (5.0 g, 33.5 mmol) in MeOH (85 mL) was added KHCO₃ (448.5 g, 0.5 mol) and CH₃I (104 mL, 1.7 mol). The mixture was stirred 7 days at room temperature. Then it was filtered washing with CH₂Cl₂. The resulting solid after evaporation was recrystallized with Hexane-CH₂Cl₂ providing the desired quaternary salt (8.6 g, 84%) in the iodide form.

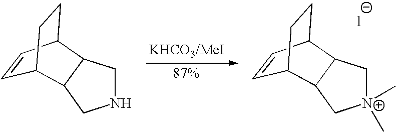

The above tetraalkylammonium iodide was transformed into the corresponding hydroxide by using an anionic resin Amberlite IRN-78, to do that 500 ml of an aqueous solution containing 152.45 g of the iodide salt was contacted with 450 g of the hydroxide for of the resin for 12 hours. The resulting mixture is continuously stirred at room temperature for 8 hours and then, the aqueous solution of the corresponding tetraalkylammonium hydroxide is recovered by filtration. The concentration of organic cation and the degree of anionic exchange is calculated by titration the OH⁻ and iodide concentrations. Typically, the exchange level is higher than 95% and the concentration of 4,4-dimethyl-4-azonium-tricycle [5.2.2.0^{2,6}]undec-8-ene cation is close to 0.8 N. The final solution is concentrated by vacuum until the organic cation concentration increases until 1 N.

### EXAMPLES

The following Examples serve to illustrate the product and method of the present invention without limiting the same. More particularly they illustrate that, where the SDA is unchanged, the positions, widths and relative intensities of peaks in the X-ray diffraction pattern depend in certain measure upon the chemical composition, in particular the trivalent (Al, B, Fe, Ga) or tetravalent (Ge, Sn, Ti, V) heteroatoms present. Also, the hydration of the sample, crystal size and crystal shape may further modify the intensities of the peaks appearing in the ITQ-41 diffraction pattern.

### Example 1

### Synthesis of Pure Silica ITQ-41 Material Having a Polymorph C to Polymorph B Ratio of 70:30

0.466 g of a 40 wt. % colloidal silica suspension (LUDOX AS-40) were added to 1.396 g of 22.7 wt. % aqueous solution of 4,4-dimethyl-4-azonium-tricycle[5.2.2.0^{2,6}]undec-8-ene hydroxide and 0.104 g of 20 wt. % of KOH. Then, 0.613 g of 10 wt. % ammonium fluoride solution was added to the above mixture. The resulting gel was stirred at room temperature until the required amount of water is evaporated to reach a water to silica ratio of 6:6. The final molar composition of the synthesis gel was:

SiO₂:0.53ROH:0.12KOH:0.53NH₄F:6.6H₂O

This gel was autoclaved at 175° C. for 14 days and the resulting solid was separated from the mother liquor by filtration and subsequently washed with distilled water at 85° C. The resulting solid is a highly crystalline material.

### Characterization of Pure Silica ITQ-41 Material Having a Polymorph C to Polymorph B Ratio of 70:30

The powder X-Ray diffraction pattern of the material ITQ-41 in its as-synthesised form as an inorganic network formed exclusively by Si and O atoms and using the 4,4-Dimethyl-4-azonium-tricycle[5.2.2.0^{2,6}]undec-8-ene cation (hereinafter SDA) was obtained in an X′Pert Pro Diffractometer using Copper Kα_{1,2} radiation and a fixed divergence slit. Table I below presents the diffraction peaks at the 2θ values and the relative intensities [(I/I₀)×100%] of those peaks, wherein I₀ is the intensity of the most intense diffraction peak. The relative intensities are classified in the following ranges: w=weak intensity (from 0 to 10); medium intensity (between 10 and 30); s=strong intensity (between 30 to 60) and vs=very strong (between 60 to 100).

TABLE I

| 2θ (degrees) | Relative Intensity (i/i₀) |
|---|---|
| 7.0034 | vs |
| 7.3590 | m |
| 8.2533 | m |
| 9.7581 | vs |
| 15.3196 | m |
| 17.0939 | m |
| 19.5893 | s |
| 21.0844 | m |
| 21.2451 | m |
| 21.7319 | m |
| 22.1765 | vs |
| 22.3255 | s |
| 23.1943 | m |
| 24.1091 | w |
| 24.9647 | w |
| 25.1900 | m |
| 26.0601 | w |
| 27.4617 | w |
| 28.2035 | m |
| 28.5779 | w |
| 28.8616 | w |
| 29.6103 | m |
| 30.8886 | w |
| 30.9878 | w |
| 31.6027 | w |
| 31.7501 | w |
| 32.4040 | w |
| 33.0653 | w |
| 33.2955 | w |
| 34.0318 | w |
| 34.8757 | w |
| 35.5566 | w |
| 36.1151 | w |
| 37.9616 | w |
| 39.7165 | w |
| 39.8420 | w |

Estimated instrumental error in the 2θ angle is ±0.05 degrees

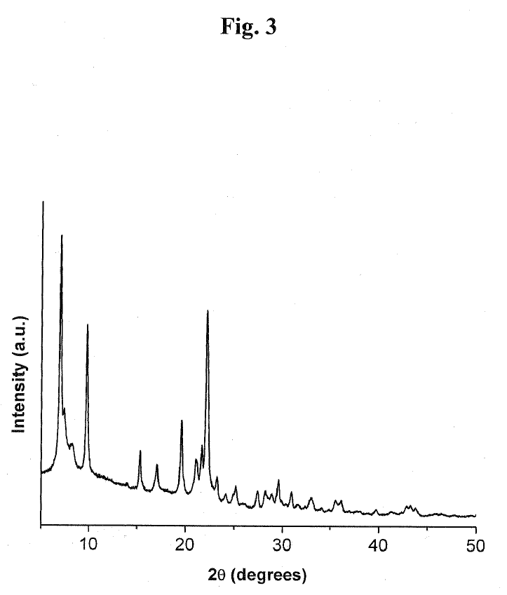

The diffractogram for the solid in this not calcined form is shown in FIG. 3.

To demonstrate the effect of roasting on the X-ray diffraction pattern, the solid was submitted to air calcination at 580° C. for 6 hours to remove the occluded organic compounds from the zeolite. Table 2 shows the 2θ angles and relative intensities (I/I₀) of the peaks of the powder X-Ray diffraction pattern. In Table 2 w, m, s and vs have the same meaning than in Table 1.

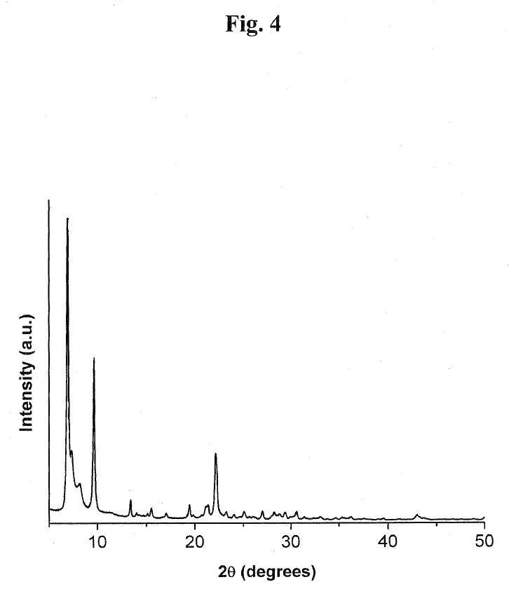

The diffractogram of the calcined solid is shown in FIG. 4.

TABLE 2

| 2θ (degrees) | Intensity (I/I₀) |
|---|---|
| 6.9840 | Vs |
| 7.3622 | M |
| 8.2589 | M |
| 9.6716 | S |
| 13.4152 | W |
| 14.0389 | W |
| 15.1544 | W |
| 15.5549 | W |
| 17.0688 | W |
| 19.4441 | W |
| 19.8581 | W |
| 20.6609 | W |
| 21.1210 | W |
| 21.2708 | W |
| 21.3983 | W |
| 22.1564 | W |
| 22.2664 | W |
| 23.3029 | W |
| 24.0697 | W |
| 25.0693 | W |
| 25.6630 | W |
| 26.0780 | W |
| 26.3316 | W |
| 27.0534 | W |
| 27.9972 | W |
| 28.2443 | W |
| 28.5300 | W |
| 28.8525 | W |
| 29.3835 | W |
| 29.9637 | W |
| 30.5967 | W |
| 31.4159 | W |
| 33.0462 | W |
| 35.2935 | W |
| 36.2778 | W |

Estimated instrumental error in the 2θ angle is ±0.05 degrees.

The X-Ray diffraction patterns of zeolite ITQ-41 in calcined and uncalcined form differ from ITQ-16, Beta and ITQ-17 zeolites in that, at low angles, the ITQ-41 material possesses four well defined reflections at 6.9°; 7.4°; 8.3°, and 9.6°. The peaks at 7.4° and 8.3° are attributed to the presence of polymorph B of Zeolite Beta in the ITQ-41 zeolite, while the diffractions at 6.9° and 9.6° are assigned to the presence of polymorph C of Beta zeolite in the ITQ-41 material. The relative intensities of these four low angle diffraction peaks could vary depending on the proportion of polymorphs C and B in the sample.

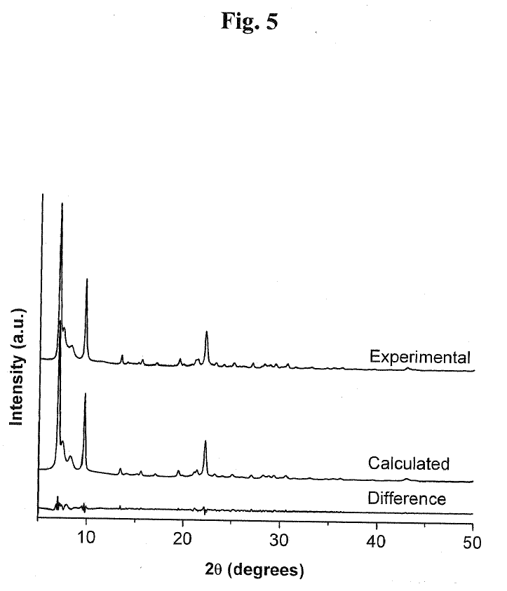

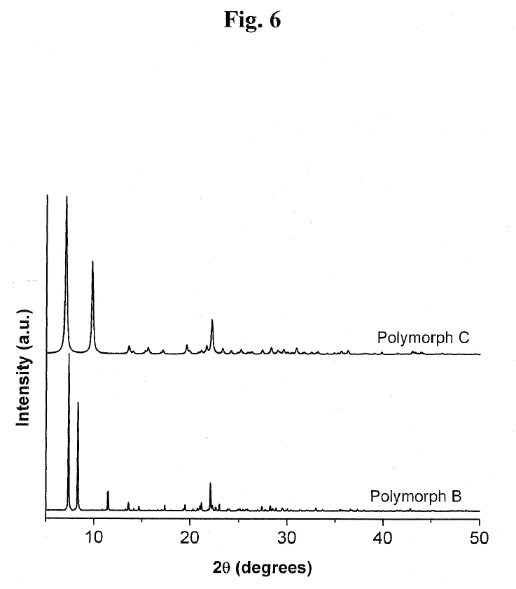

The Rietveld analysis of the X-Ray diffraction pattern of FIG. 4 indicates that these ITQ-41 materials are formed by polymorph C and polymorph B in a proportion 70 to 30. The experimental and calculated patterns as well as the difference pattern between both diffractograms are shown in FIG. 5. This indicates without ambiguity that the ITQ-41 material is formed by two equivalent polymorphs, that correspond to the structures of those proposed by Newsam for the polymorph B and C of the zeolite Beta, while the polymorph A, present in zeolite beta, is absent in the ITQ-41 material. The individual diffraction patterns for polymorphs B and C are shown in FIG. 6.

### Example 2

### Synthesis of Pure Silica ITQ-41 Material Having a Polymorph C to Polymorph B Ratio of 40:60

0.364 g of a 40 wt. % colloidal silica suspension (LUDOX AS-40) were added on 1.090 g of 22.3 wt. % aqueous solution of 4,4-dimethyl-4-azonium-tricycle[5.2.2.0^{2,6}]undec-8-ene hydroxide prepared following the Example 1 and 0.178 g of 20 wt. % of KOH. Then, 0.687 g of 10 wt. % ammonium fluoride solution were added to the above mixture. The resulting gel was stirred at room temperature until the required amount of water is evaporated to reach a water to silica ratio of 7:8. The final molar composition of the synthesis gel was:

SiO₂:0.51ADEOH:0.27KOH:0.77NH₄F:7.8H₂O

This gel was autoclaved at 175° C. for 14 days and the resulting solid was separated from the mother liquor by filtration and subsequently washed with distilled water at 85° C. The resulting solid gives the X-Ray diffraction pattern shown in FIG. 4 (MMALF 72).

The solid was submitted to air calcination at 580° C. for 6 hours to remove the occluded organic compounds. The resulting ITQ-41 material possesses an X-Ray pattern that can be conveniently adjusted by Rietveld refinement as composed by 40% of the polymorph C described for the Beta zeolite by Newsam and 60% of polymorph B described for the Beta zeolite by Newsam.

### Example 3

### Synthesis of Pure Silica ITQ-41 Material Having a Polymorph C to Polymorph B Ratio of 8:92

0.466 g of a 40 wt. % colloidal silica suspension (LUDOX AS-40) were added on 1.376 g of 21.3 wt. % aqueous solution of 4,4-dimethyl-4-azonium-tricycle[5.2.2.02]undec-8-ene hydroxide prepared following the Example 1 and 0.453 g of 20 wt. % of KBr. Then, 0.554 g of 10 wt. % ammonium fluoride solution was added to the above mixture. The resulting gel was stirred at room temperature until the required amount of water is evaporated to reach a water to silica ratio of 2:6. The final molar composition of the synthesis gel was:

SiO₂:0.48ADEOH:0.25KBr:0.48NH₄F:2.6H₂O

This gel was autoclaved at 175° C. for 14 days and the resulting solid was separated from the mother liquor by filtration and subsequently washed with distilled water at 85° C. The resulting solid gives the X-Ray diffraction pattern shown in FIG. 5 (MMALF157).

The solid was submitted to air calcination at 580° C. for 6 hours to remove the occluded organic compounds. The resulting ITQ-41 material possesses an X-Ray pattern that can be conveniently adjusted by Rietveld refinement as composed by 8% of the polymorph C described for the Beta zeolite by Newsam and 92% of polymorph B described for the Beta zeolite by Newsam.

### Example 4

### Synthesis of Pure Silica ITQ-41 Material Having a Polymorph C to Polymorph B Ratio of 100:0

0.468 g of a 40 wt. % colloidal silica suspension (LUDOX AS-40) were added on 1.391 g of 22.7 wt. % aqueous solution of 4,4-dimethyl-4-azonium-tricycle[5.2.2.0^{2,6}]undec-8-ene hydroxide prepared following the Example 1 and 0.213 g of 20 wt. % of KOH. Then, 0.595 g of 10 wt. % ammonium fluoride solution was added to the above mixture. The resulting gel was stirred at room temperature until the required amount of water is evaporated to reach a water to silica ratio of 6:8. The final molar composition of the synthesis gel was:

SiO₂:0.53ADEOH:0.23KOH:0.52NH₄F:6.8H₂O

This gel was autoclaved at 175° C. for 14 days and the resulting solid was separated from the mother liquor by filtration and subsequently washed with distilled water at 85° C. The resulting solid gives the X-Ray diffraction pattern shown in FIG. 6 (MMALF170).

The solid was submitted to air calcination at 580° C. for 6 hours to remove the occluded organic compounds. The resulting ITQ-41 material possesses an X-Ray pattern that can be conveniently adjusted by Rietveld refinement as exclusively composed by the polymorph C described for the Beta zeolite by Newsam.

### Example 5

### Enrichment of ITQ-41 Materials in Polymorph C

In this Example, the enrichment of a ITQ-41 sample having a ratio of polymorph C to polymorph B=15:85 to yield a final ITQ-XX materials with a proportion between polymorphs C to B of 75:25 is shown. 0.125 g of ITQ-41 with a ratio of polymorph C to polymorph B of 15:85, were added on 0.848 g of 22.7 wt. % aqueous solution of 4,4-dimethyl-4-azonium-tricycle[5.2.2.02 6]undec-8-ene hydroxide prepared following the example 1 and 0.146 g of 20 wt. % of KOH. Then, 0.360 g of 10 wt. % ammonium fluoride solution was added to the above mixture. The resulting gel was stirred at room temperature until the required amount of water is evaporated to reach a water to silica ratio of 8:1. The final molar composition of the synthesis gel was:

SiO₂:0.57ADEOH:0.29KOH:0.55NH₄F:8.1H₂O

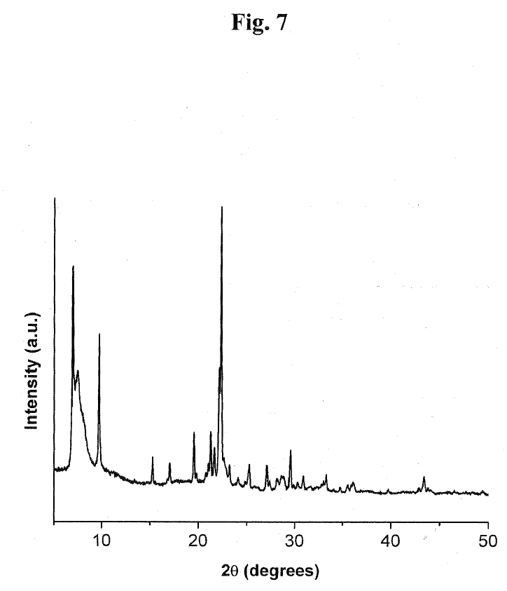

This gel was autoclaved at 175° C. for 14 days and the resulting solid was separated from the mother liquor by filtration and subsequently washed with distilled water at 85° C. The resulting solid gives the X-Ray diffraction pattern shown in FIG. 7 (MMALF039)

The solid was submitted to air calcinations at 580° C. for 6 hours to remove the occluded organic compounds. The resulting ITQ-41 material possesses an X-Ray pattern that can be conveniently adjusted by Rietveld refinement as composed by 75% of the polymorph C described for the Beta zeolite by Newsam and 25% of polymorph B described for the Beta zeolite by Newsam.

1. A crystalline microporous material of zeolitic nature having in its calcined form a chemical composition represented by the empirical formula:
x(M_{1/n}XO₂):yYO₂:SiO₂
wherein,
Y is a chemical element other than Silicon with oxidation status +4;
X is a chemical element with oxidation status +3;
M is H⁺ or an inorganic cation with charge n⁺;
n can take any value in the range from 1 to 3;
x can take any value greater than or equal to 0 and less than about 0.2, and
y can take any value greater than or equal to 0 and less than about 0.2, and
wherein, said material is characterized by the presence of four reflections in its powder X-Ray diffraction pattern at 6.9°, 7.4°, 8.3° and 9.6° 2θ angles.

2. The microporous material according to claim 1, wherein Y comprises at least one element selected from the group consisting of Ge, Ti, Sn, V and Sn.

3. The microporous material according to claim 1, wherein X comprises at least one element selected from the group consisting of Al, Ga, B, Cr and Fe.

4. The microporous material according to claim 1, wherein M comprises at least one cation selected from the group consisting of H⁺, Li⁺, Na⁺, K⁺, Ca²⁺ and Mg²⁺.

5. The microporous material according to claim 1, wherein x is greater than or equal to 0 and less than about 0.05.

6. The microporous material according to claim 1, wherein y is greater than or equal to 0 and less than about 0.1.

7. The microporous material according to claim 1, having in its calcined form a chemical composition represented by the formula:
x(HXO₂):SiO₂
wherein, x has a value greater than or equal to 0 and less than about 0.02.

8. The microporous material according to claim 1, wherein x=0 and y=0.

9. The microporous material according to claim 8, characterized in that its powder X-Ray diffraction pattern can be fitted by Rietveld Refinement as a combination of polymorphs B and C.

10. The microporous material according to claim 9, wherein the ratio of polymorph B to polymorph C is in the range from about 100:0 to about 0:100.

11. The microporous material according to claim 10, wherein the ratio of polymorph B to C is in the range from about 5:95 to about 95:5.

12. A method for synthesizing the microporous crystalline material of zeolitic nature as defined in claim 1, comprising:
a) providing a reaction mixture comprising:
a source of silica (SiO₂);
a source of the 4,4-dimethyl-4-azonium-tricyclo[5,2,2,026]undec-8-ene cation as a structure directing agent, said cation hereinafter being denoted as R+;
a source of fluoride ions;
a source of Y, where applicable;
a source of X, where applicable, and
water, and
wherein, said reaction mixture has a composition, calculated in terms of oxide unless otherwise directed, of:
X₂O₃/SiO₂ ranges from 0 to about 0.2
ROH/SiO₂ ranges from about 0.01 to about 3
YO₂/SiO₂ ranges from 0 to about 0.2
H₂O/SiO₂ ranges from about 1000 to about 0.25
HF/SiO₂ ranges from about 0.01 to about 3.0
b) subjecting said mixture to heating at a temperature between about 110 to about 250° C., and at a pH between about 5 to about 10 until crystallization is obtained.

13. The method according to claim 12, wherein the crystalline solid product of step b) is recovered from the mother liquor by filtration and/or centrifugation, followed by drying at a temperature between about 25 and about 150° C.

14. The method according to claim 13, wherein said crystalline solid product of step b) is calcined under vacuum, in air, N₂ or other inert gas at temperatures between about 400° C. to about 1200° C.

15. The method according to claim 12, wherein said source of silicon comprises at least one of amorphous silica, colloidal silica, silica gel, tetraalkylorthosilicate and preformed zeolite.

16. The method according to claim 12, wherein said structure directing agent (R+) is present in the reaction mixture in at least one of its hydroxide, nitrate, chlorate, sulphate, bisulphate, carbonate, bicarbonate forms.

17. The method according to claim 12, wherein said source of fluoride comprises at least one of hydrofluoric acid, ammonium fluoride, alkaline metal fluoride and alkaline-earth metal fluoride.

18. The method according to claim 12, wherein said reaction mixture further comprises a source of alkaline or alkaline earth cations.

19. The method according to claim 18, wherein said alkaline or alkaline earth cations are present in the form of their hydroxides, halides, nitrates, chlorates, sulphates, bisulphates, carbonates or mixtures thereof.

20. The method according to claim 19, wherein said source of alkaline or alkaline earth cations comprises potassium hydroxide.

21. The method according to claim 18, wherein the composition of the reaction mixture is further characterized by the ratios:
A/SiO₂ ranges from about 3 to about 0.01, and
A/ROH ranges from 0 to about 5,
wherein, A denotes the alkaline or alkaline earth metal cations.

22. The use of a crystalline microporous material of zeolitic nature as defined in claim 1 as a molecular sieve in fluid separation; in ion-exchange processes; or, as a catalyst, as a component of a catalyst or as an additive to a catalyst.
